(19) United States
(12) Patent Application Publication
(10) Pub. No.: US 2012/0278836 A1
(43) Pub. Date: Nov. 1, 2012

(54) ELECTRONIC DEVICE AND DISPLAY METHOD

(76) Inventors: MUNEHIRO TOKIKURA, Kawasaki-shi (JP); NAOKI ESAKA, Tachikawa-shi (JP); MIEKO ONODERA, Kawasaki-shi (JP); SACHIE YOKOYAMA, Ome-shi (JP)

(21) Appl. No.: 13/345,299

(22) Filed: Jan. 6, 2012

(30) Foreign Application Priority Data
Apr. 27, 2011 (JP) 2011-099748

(51) Int. Cl. H04N 21/472

(52) U.S. Cl. 725/40

(57) ABSTRACT

According to one embodiment, an electronic device includes a generator configured to generate key information items associated with the information integration screen information items, a selection module configured to select one information integration screen information item from information integration screen information items based on in-device information and key information items the in-device information includes the electronic program table data acquired from the electronic device, and the key information items associated with the respective information integration screen information items, and a display data generator configured to generate display data to display, on a display screen, an information integration screen includes one or more Web page and/or the specified area of Web page, the information integration screen corresponding to the one information integration screen information selected by the selection module.

### CROSS-REFERENCE TO RELATED APPLICATIONS

This application is based upon and claims the benefit of priority from prior Japanese Patent Application No. 2011-099748, filed Apr. 27, 2011, the entire contents of which are incorporated herein by reference.

### FIELD

Embodiments described herein relate generally to an electronic device configured to generate display data for simultaneously displaying one or more Web pages or specified areas of the Web pages and a display method.

### BACKGROUND

Television receivers that can display Web sites are sold.

It is considered to display a Web information integration screen on which one or more Web pages or specified areas (also referred to as “Web clips”) of the Web pages are provided on the display screen of a display. It is also considered to previously store a plurality of Web information integration screen data items including the arrangement position, size, address and the like of the Web page or Web clip in the Web information integration screen in a storage device and display a Web information integration screen corresponding to the Web information integration screen data selected by the operation of the user later. The user operates a remote controller to select the Web information integration screen data, but the selection operation cannot be easily performed by means of the remote controller. Therefore, for example, it is desirable to provide a display button used for instructing display of a Web information integration screen on the remote controller and automatically select optimum Web information integration screen data according to the operation of the display button.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary block diagram showing the system configuration of an electronic device of a first embodiment.

FIG. 2 is an exemplary view showing a Web information integration screen displayed on the electronic device of the first embodiment.

FIG. 3A, FIG. 3B and FIG. 3C are views for illustrating an example in which a key information acquisition module shown in FIG. 1 acquires key information from Web information integration screen data.

FIG. 4 is an exemplary flowchart for illustrating a procedure in which the electronic device of the first embodiment displays a Web information integration screen.

FIG. 5 is an exemplary block diagram showing the system configuration of an electronic device of a second embodiment.

FIG. 6A, FIG. 6B and FIG. 6C are views for illustrating an example in which a key information acquisition module shown in FIG. 5 acquires key information from Web information integration screen data.

FIG. 7 is an exemplary flowchart for illustrating a procedure in which the electronic device of the second embodiment displays a Web information integration screen.

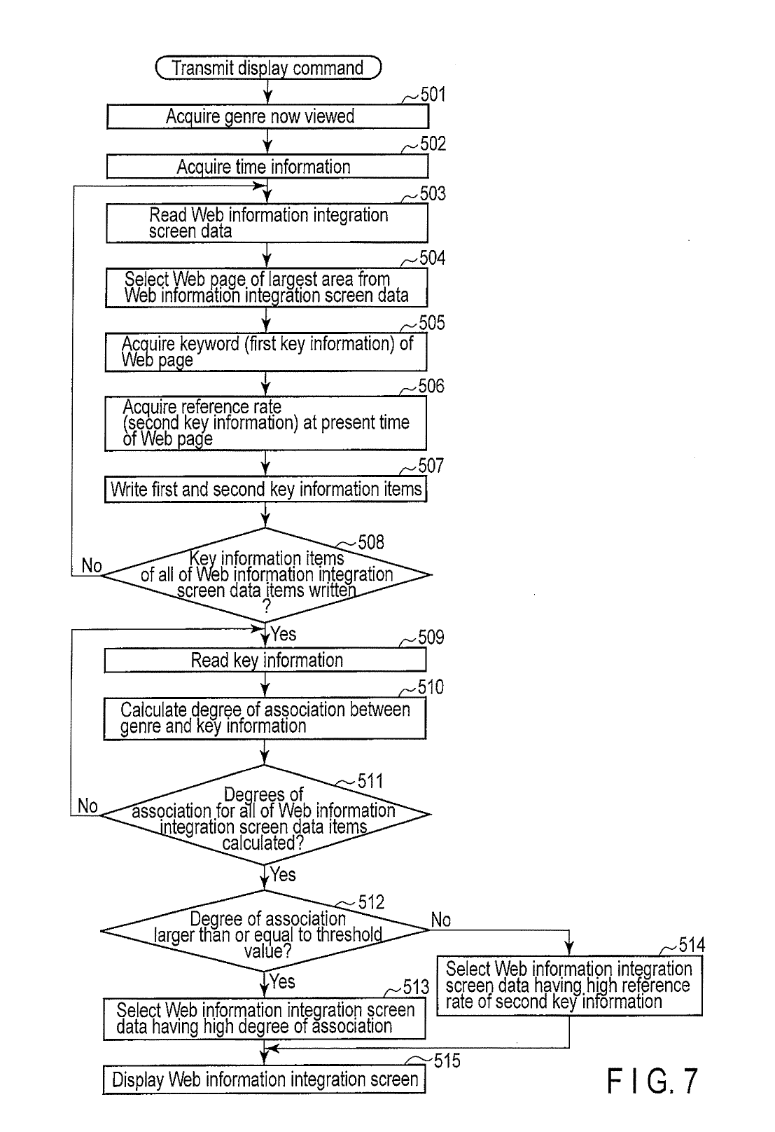

FIG. 8A, FIG. 8B and FIG. 8C are views for illustrating an example in which key information is acquired from Web information integration screen data.

FIG. 9A, FIG. 9B and FIG. 9C are view for illustrating an example in which key information is acquired from Web information integration screen data.

FIG. 10A and FIG. 10B are views for illustrating an example in which key information is acquired from Web information integration screen data.

FIG. 11A and FIG. 11B are views for illustrating an example in which key information is acquired from Web information integration screen data.

FIG. 12A and FIG. 12B is a view for illustrating an example in which key information is acquired from Web information integration screen data.

FIG. 13A, FIG. 13B and FIG. 13C are views for illustrating an example in which key information is acquired from Web information integration screen data.

### DETAILED DESCRIPTION

Various embodiments will be described hereinafter with reference to the accompanying drawings.

In general, according to one embodiment, an electronic device comprises a storage module, a reception module, a transmission module, a generator, a selection module, and a display data generator. The storage module is configured to store information integration screen information items, each integration screen information item comprising information of one or more Web page and/or specified area of Web page. The reception module is configured to receive broadcasting program data comprising electronic program table data. The transmission module is configured to transmit a display command to display an information integration screen when a signal for displaying the information integration screen is received from an exterior. The generator is configured to generate key information items associated with the information integration screen information items. The selection module is configured to select one information integration screen information item from the information integration screen information items based on in-device information and key information items when the transmission module transmits the display command, the in-device information comprising the electronic program table data acquired from the electronic device, and the key information items associated with the respective information integration screen information items. The display data generator is configured to generate display data to display, on a display screen, an information integration screen comprising one or more Web page and/or the specified area of Web page, the information integration screen corresponding to the one information integration screen information selected by the selection module.

### First Embodiment

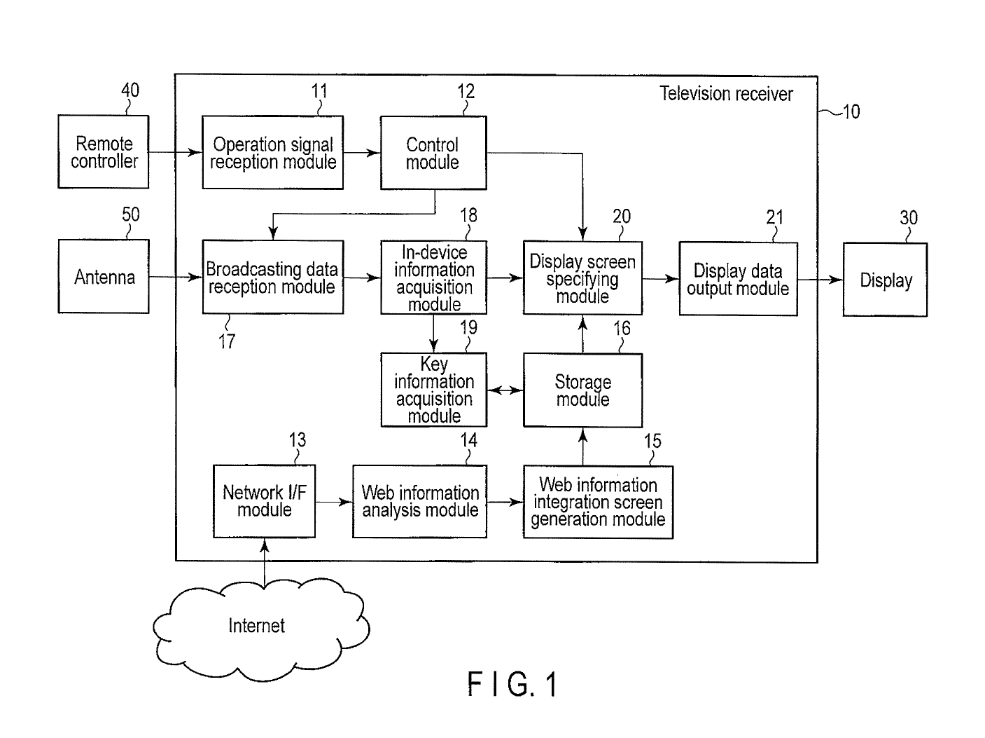

FIG. 1 is a block diagram showing the system configuration of an electronic device of a first embodiment. For example, the electronic device is realized as a television receiver 10. Further, the electronic device may be realized as a recorder (for example, a hard disk recorder, DVD recorder), personal computer (PC), tablet PC, straight PC, PDA, car navigation device, smart phone or the like.

The television receiver 10 includes an operation signal reception module 11, control module 12, network I/F module 13, Web information analysis module 14, Web information integration screen generation module 15, storage module 16, broadcasting data reception module 17, in-device information acquisition module 18, key information acquisition module 19, display screen specifying module 20, display data output module 21 and the like.

The operation signal reception module 11 receives an operation signal transmitted from a remote controller 40 and corresponding to a button operated by the user and outputs a signal corresponding to the received operation signal to the control module 12. A display instruction button for instructing display of a Web information integration screen is provided on the remote controller. When the display instruction button is operated, the remote controller 40 transmits a display instruction signal. When receiving a display instruction reception signal, the operation signal reception module 11 transmits the display instruction reception signal to the control module 12.

The network I/F module 13 makes communication with the Web site on the Internet to receive Web page data. The Web information analysis module 14 analyzes the Web page data received via the network I/F module 13 and calculates the arrangement of objects such as characters and images displayed on the display screen.

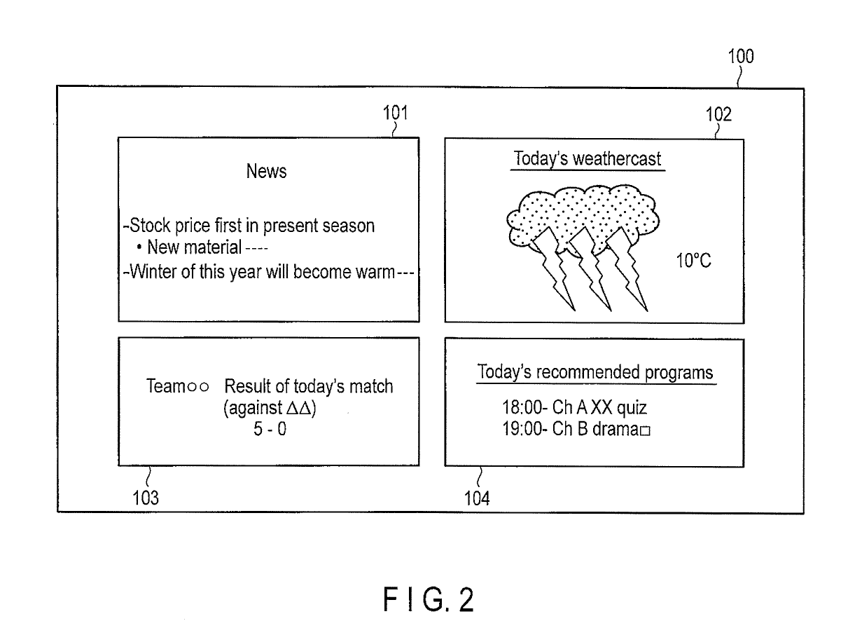

The Web information integration screen generation module 15 generates a Web information integration screen based on the analysis result of the Web information analysis module 14 and an operation signal based on the operation of the remote controller 40. One example of the Web information integration screen displayed on the display screen is shown in FIG. 2. As shown in FIG. 2, in a Web information integration screen 100, a plurality of Web pages or Web clips 101 to 104 are arranged in one screen. The user can simultaneously browse information items of the plural Web pages or Web clips 101 to 104.

The Web information integration screen generation module 15 stores Web information integration screen data (address, arrangement position and the like of the Web site) of the generated Web information integration screen in the storage module 16. The storage module 16 can store a plurality of Web information integration screen data items. The Web information integration screen data may be generated based on a plurality of Web pages or a single Web page. Further, the Web page itself can be made equivalent to the Web information integration screen.

When receiving the display instruction reception signal transmitted from the operation signal reception module 11, the control module 12 transmits a display command for displaying a Web information integration screen to the broadcasting data reception module 17 and display screen specifying module 20.

When receiving the display command, the broadcasting data reception module 17 transmits broadcasting data that can be acquired from broadcasting waves received by an antenna 50 to the in-device information acquisition module 18.

The in-device information acquisition module 18 extracts the name of a program (program name) now received from EPG (Electronics Program Guide) data superimposed on the received broadcasting data in response to reception of the display command and transmits the program name to the display screen specifying module 20.

The key information acquisition module 19 acquires key information from Web information integration screen data stored in the storage module 16. The key information acquisition module 19 stores the acquired key information in correspondence to the Web information integration screen data in the storage module 16.

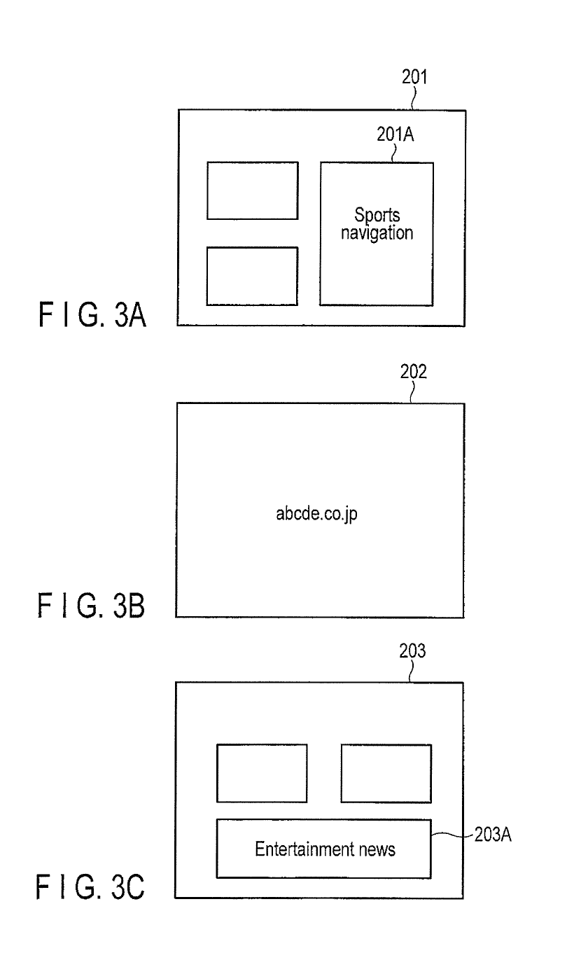

For example, as shown in FIG. 3A, FIG. 3B and FIG. 3C, it is assumed that Web information integration screen data items corresponding to Web information integration screens 201, 202 and 203 are stored in the storage module 16. The key information acquisition module 19 acquires key information from a Web page (Web clip) 201A having a large display area from Web pages (Web clips) displayed on the Web information integration screen 201. The key information acquisition module 19 acquires key information from a Web page (Web clip) 202A having a large display area from Web pages (Web clips) displayed on the Web information integration screen 202. The key information acquisition module 19 acquires key information from a Web page (Web clip) 203A having a large display area from Web pages (Web clips) displayed on the Web information integration screen 203. For example, the key information is a site name.

When receiving a program name transmitted from the in-device information acquisition module 18 after the display command transmitted from the control module 12 is received, the display screen specifying module 20 calculates the degree of association between the Web information integration screen data items stored in the storage module 16 and the program name, selects the Web information integration screen data having the highest degree of association, selects a Web information integration screen to be displayed on a display 30 and outputs the selected Web information integration screen data to the display data output module 21.

For example, the program name and key information are pattern-matched for each character and the number of characters that coincide is used as the degree of association. If key information items of “talent information”, “sports” and “weathercast” are provided for a program name of “entertainment news”, the degree of association of “talent information” is “1” and the degrees of association of “sports” and “weathercast” are “0”.

Further, for example, words that coincide are detected based on a database including synonyms of words. When words that have approximately equal meanings are represented in a tree structure in the database, the depth thereof is used as the degree of association. The database may be configured as a generally prepared database or independent database. Further, the database may be placed on a server arranged on the Internet or on the television receiver 10.

When EPG data of a certain program is acquired, the names of performers and words used in a genre or title are acquired and registered in the database on the assumption that they are related to the program. Thus, by performing the above operation for each of a plurality of programs, a database is constructed in a thesaurus fashion.

When receiving Web information integration screen data, the display data output module 21 instructs the network I/F module 13 to receive a Web page based on the Web information integration screen data. The Web information analysis module 14 analyzes the Web page data received by the network I/F module 13 and calculates the arrangement of objects such as characters and images displayed on the display screen. The Web information integration screen generation module 15 generates data used for displaying a Web information integration screen on which one or more Web pages or Web clips are arranged based on the analysis result of the Web information analysis module 14 and Web information integration screen data. The display data output module 21 generates display data to be displayed on the display screen of the display 30 based on the thus generated data.

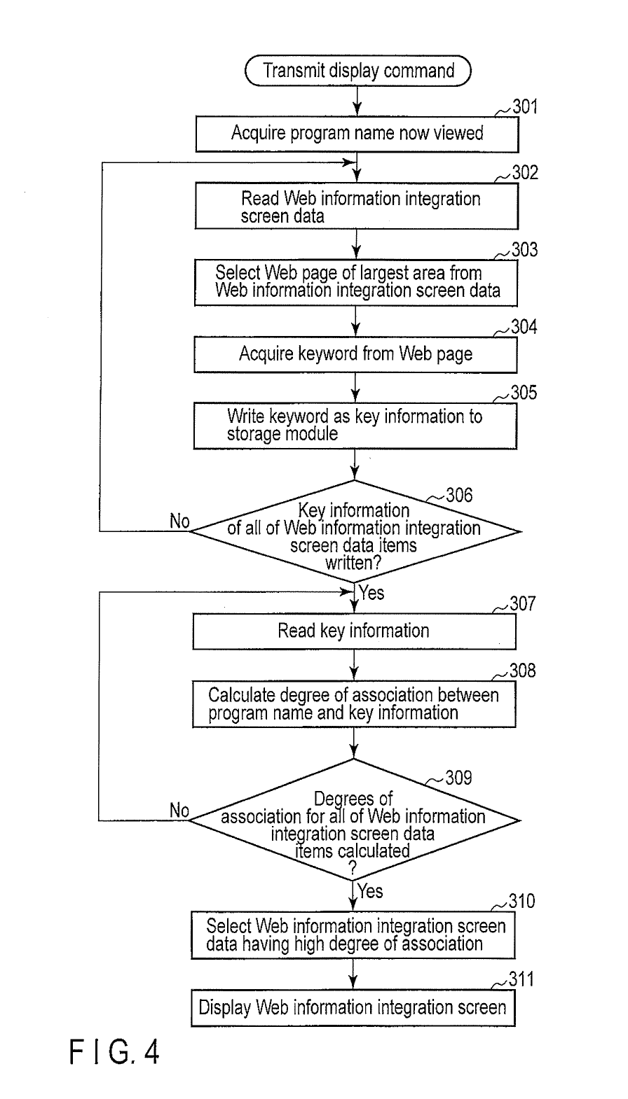

Next, one example of a procedure from transmission of a display command to display of a Web information integration screen is explained with reference to the flowchart of FIG. 4.

The in-device information acquisition module 18 acquires a program name now viewed from EPG data included in broadcasting program data (block 301). The in-device information acquisition module 18 transmits the acquired program name now viewed to the display screen specifying module 20. The key information acquisition module 19 reads Web information integration screen data from the storage module 16 (block 302). The key information acquisition module 19 selects a Web page or Web clip having the largest area from the Web information integration screen data (block 303). The key information acquisition module 19 acquires a keyword (site name) from the selected Web page or Web clip (block 304). The key information acquisition module 19 writes the keyword as key information of the Web information integration screen data acquired in the block 302 in association with the Web information integration screen data to the storage module 16 (block 305). The key information acquisition module 19 determines whether or not key information items for all of the Web information integration screen data items stored in the storage module 16 have been stored in the storage module 16 (block 306). If it is determined that key information items are not stored in the storage module 16 (No in block 306), the process returns to the block 302 and different Web information integration screen data is acquired. If it is determined that key information items are stored in the storage module 16 (Yes in block 306), the display screen specifying module 20 reads key information of Web information integration screen data from the storage module 16 (block 307). The degree of association between the read key information and the program name acquired in the block 301 is calculated (block 308). The display screen specifying module 20 determines whether or not the degrees of association with respect to all of the Web information integration screen data items stored in the storage module 16 are calculated (block 309). If it is determined that the degrees of association are not calculated (No in block 309), the display screen specifying module 20 returns the process to the block 307. If it is determined that the degrees of association are calculated (Yes in block 309), the display screen specifying module 20 selects Web information integration screen data having the highest degree of association among the calculated degrees of association (block 310). The display data output module 21 generates data used for displaying a Web information integration screen corresponding to the selected Web information integration screen data on the display 30. The Web information integration screen is displayed on the display 30 based on the generated data (block 311).

The degrees of association between the program name now viewed and the site names of Web pages or Web clips in the Web information integration screen displayed based on the Web information integration screen information are generated, Web information integration screen information having the highest degree of association is selected and a Web information integration screen corresponding to the selected Web information integration screen information is displayed. Thus, an optimum Web information integration screen can be displayed.

### Second Embodiment

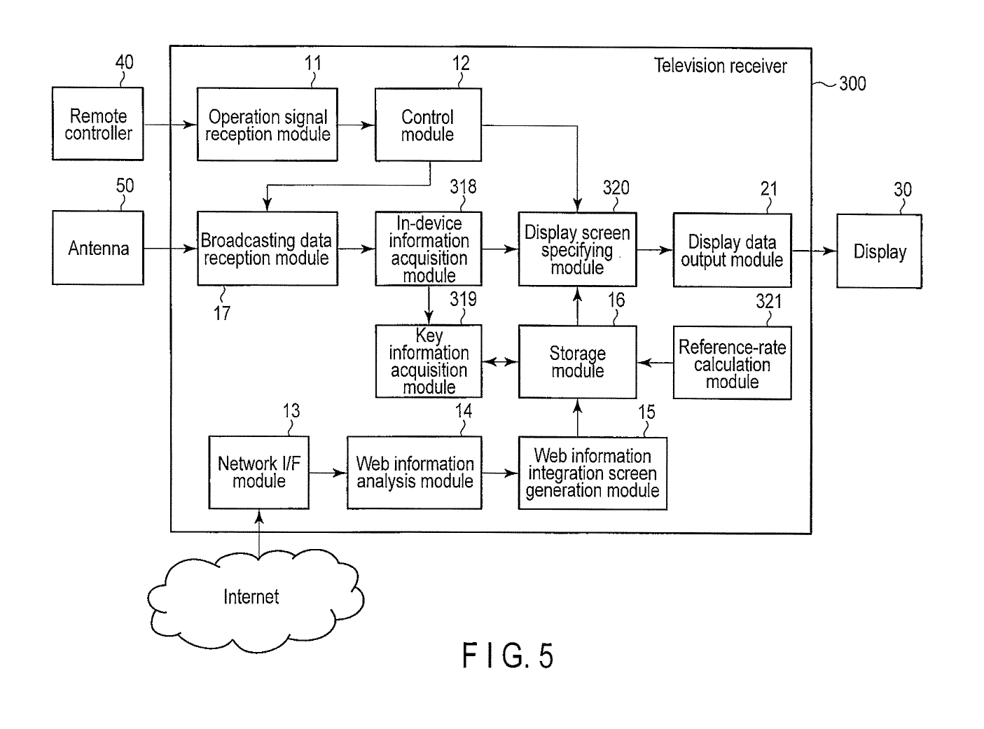

FIG. 5 is a block diagram showing the configuration of a television receiver 300 of a second embodiment.

The television receiver 300 includes an operation signal reception module 11, control module 12, network I/F module 13, Web information analysis module 14, Web information integration screen generation module 15, storage module 16, broadcasting data reception module 17, in-device information acquisition module 318, key information acquisition module 319, reference-rate calculation module 321, display screen specifying module 320, display data output module 21 and the like.

In response to reception of a display command, the in-device information acquisition module 318 extracts the genre of a program now received from EPG data superimposed on received broadcasting data, extracts time information superimposed on the broadcasting data and transmits the genre and time information to the display screen specifying module 320. Further, the in-device information acquisition module 318 transmits the time information to the key information acquisition module 319.

The reference-rate calculation module 321 calculates a reference rate according to display time of a Web information integration screen that is not automatically displayed by the operation of a Web information integration screen display button but displayed by the operation of the user. For example, the reference-rate calculation module 321 divides one day into a plurality of time zones and calculates a reference rate of each Web information integration screen in each time zone. The reference rate of each Web information integration screen in each time zone is stored in the storage module 16.

The key information acquisition module 319 acquires first key information from a Web page or Web clip having a large display area among the Web pages or Web clips displayed on the Web information integration screen. Further, the key information acquisition module 319 acquires a reference rate of each Web information integration screen in a time zone corresponding to time information as second key information. The key information acquisition module 319 stores the first and second key information items in association with the Web information integration screen.

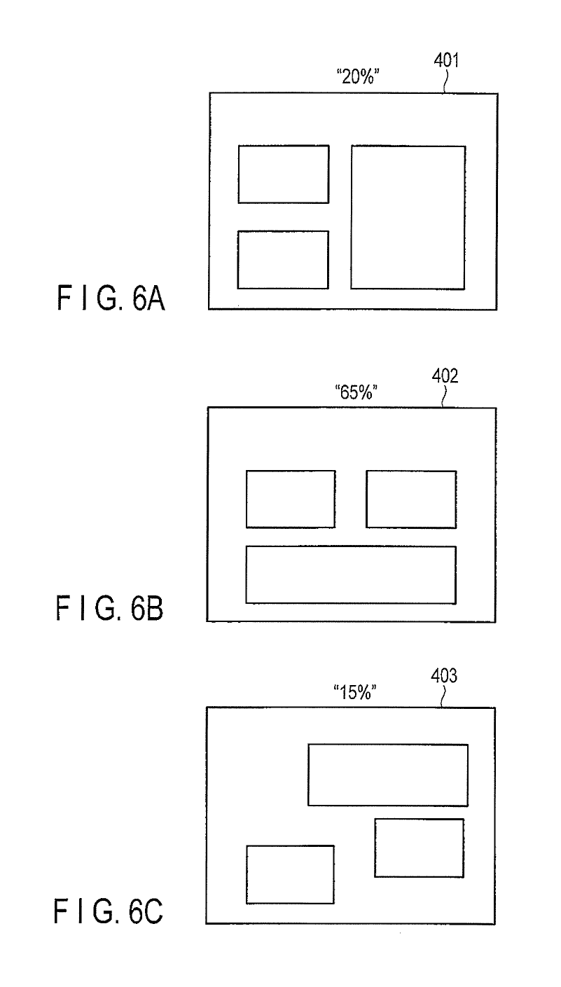

For example, it is assumed that Web information integration screen data items corresponding to Web information integration screens 401, 402 and 403 shown in FIG. 6A, FIG. 6B and FIG. 6C are stored in the storage module 16. The key information acquisition module 319 acquires 20% from the storage module 16 as a reference rate of Web information integration screen data corresponding to the Web information integration screen 401 and stores 20% in association with the Web information integration screen data in the storage module 16. The key information acquisition module 319 acquires 65% from the storage module 16 as a reference rate of Web information integration screen data corresponding to the Web information integration screen 402 and stores 65% in association with the Web information integration screen data in the storage module 16. The key information acquisition module 319 acquires 15% from the storage module 16 as a reference rate of Web information integration screen data corresponding to the Web information integration screen 403 and stores 15% in association with the Web information integration screen data in the storage module 16.

When receiving the genre transmitted from the in-device information acquisition module 318 after a display command transmitted from the control module 12 is received, the display screen specifying module 320 calculates the degrees of association between the genre and respective Web information integration screen data items stored in the storage module 16. The display screen specifying module 320 determines whether or not the degree of association that is higher than a threshold value is present. If it is determined that the degree of association that is higher than the threshold value is present, the display screen specifying module 320 selects Web information integration screen data having the highest degree of association. If it is determined that the degree of association that is higher than the threshold value is not present, the display screen specifying module 320 selects a Web information integration screen associated with the highest reference rate among the reference rates stored in the storage module 16 as second key information.

The in-device information acquisition module 318 acquires a genre of a program now viewed from EPG data (block 501). The in-device information acquisition module 318 transmits the genre to the display screen specifying module 320. The in-device information acquisition module 318 acquires time information superimposed on broadcasting waves (block 502). The in-device information acquisition module 318 transmits time information to the key information acquisition module 319.

The key information acquisition module 319 reads Web information integration screen data from the storage module 16 (block 503). The key information acquisition module 319 selects a Web page or Web clip having the largest area from a Web information integration screen displayed according to the Web information integration screen data (block 504). A keyword (first key information) is acquired from the selected Web page or Web clip (block 505). The key information acquisition module 319 acquires the reference rate at the present time of Web information integration screen data (block 506). The key information acquisition module 319 stores the keyword set as first key information and the reference rate set as second key information in association with the Web information integration screen data in the storage module 16 (block 507). The key information acquisition module 319 determines whether or not the first and second key information items of all of the Web information integration screen data items are written to the storage module (block 508).

When it is determined that key information items are acquired from all of the Web information integration screen data items, the display screen specifying module 320 reads first and second key information items of the key information acquisition module 319 from the storage module 16 (block 509). The display screen specifying module 320 calculates the degree of association between the genre of the program and the first key information (block 510). The display screen specifying module 320 determines whether or not the degrees of association for all of the Web information integration screen data items are calculated (block 511). When it is determined that the degrees of association for all of the Web information integration screen data items are calculated, the display screen specifying module 320 determines whether the highest degree of association among the calculated degrees of association is not less than a threshold value (block 512). If it is determined that the degree is not less than the threshold value (Yes in block 512), Web information integration screen data having the highest degree of association among the calculated degrees of association is selected (block 513). If it is determined that the degree is less than the threshold value (No in block 512), Web information integration screen data associated with the highest reference rate among the reference rates stored as the second key information in the storage module is selected (block 514). The display data output module 21 generates data used for displaying a Web information integration screen corresponding to the selected Web information integration screen data on a display 30 and the Web information integration screen is displayed on the display 30 according to the generated data (block 515).

The degrees of association between the genre of a program now viewed and the site names of Web pages or Web clips in the Web information integration screen displayed based on the Web information integration screen information are generated, Web information integration screen information having the highest degree of association is selected when the highest degree of association is not less than the threshold value, Web information integration screen information having the highest reference rate is selected when the highest degree of association is less than the threshold value, and a Web information integration screen corresponding to the selected Web information integration screen information is displayed. Thus, an optimum Web information integration screen can be displayed.

(Modification of Key Information)

An example of key information is shown below.

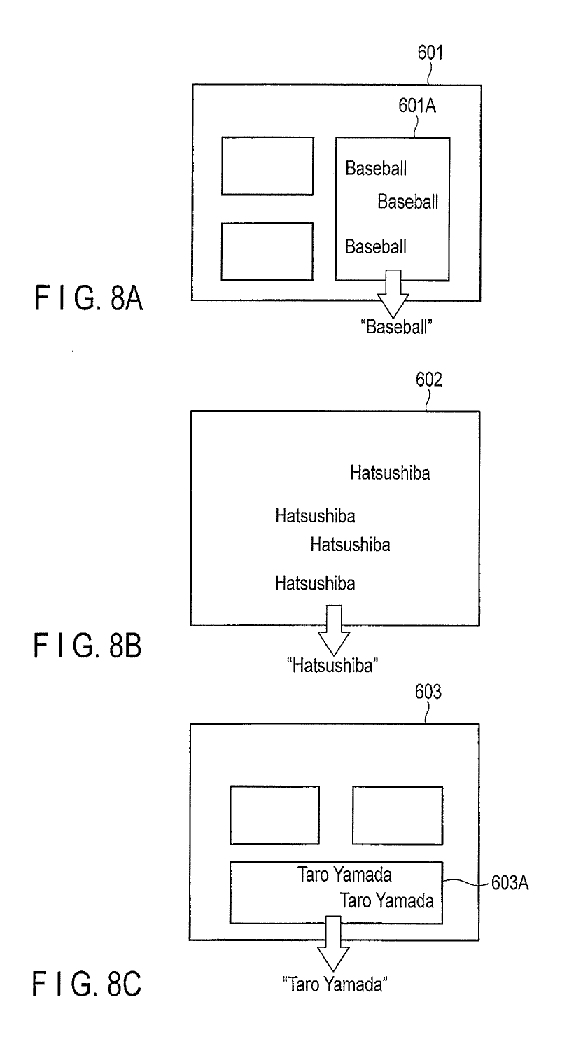

(1) A highest-frequency word in a Web page or Web clip having the largest occupied area in the Web information integration screen is used as key information. For example, a case where Web information integration screens 601, 602 and 603 shown in FIG. 8A, FIG. 8B and FIG. 8C are taken as an example is explained. Baseball that is a highest-frequency word in a Web page or Web clip 601A having the largest occupied area in the Web information integration screen 601 shown in FIG. 8A is used as key information. Further, since the Web information integration screen 602 shown in FIG. 8B is configured by one Web page, “hatsushiba” that is a highest-frequency word in the Web information integration screen 602 is used as key information. Additionally, Taro Yamada that is a highest-frequency word in a Web page or Web clip 603A having the largest occupied area in the Web information integration screen 603 shown in FIG. 8C is used as key information.

(2) The user operates a remote controller 40 to place the focus on one Web page or Web clip in the Web information integration screen. By the operation of the remote controller by the user after placing the focus, the television receiver displays only the Web page or Web clip on which the focus is placed. The television receiver stores the genre of the Web page or Web clip on which the focus is placed when the Web information integration screen is finally displayed in the storage module 16. The genre of the displayed Web page or Web clip may be acquired by previously preparing a database having a corresponding relationship between words and genres and retrieving a genre corresponding to the site name from the database.

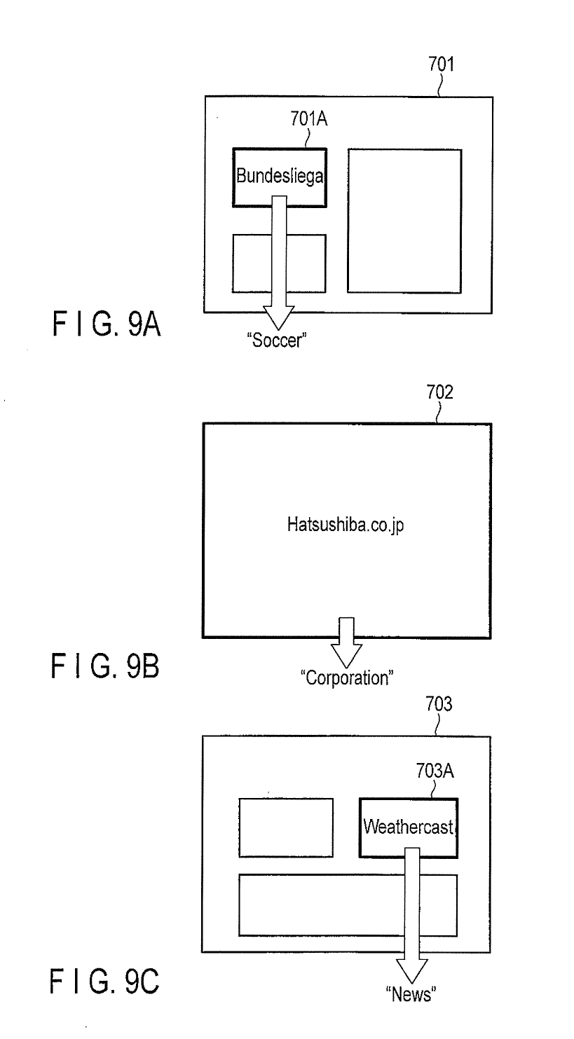

For example, a case where Web information integration screens 701, 702 and 703 shown in FIG. 9A, FIG. 9B and FIG. 9C are taken as an example is explained. Soccer associated with Bundesliega that is the site name of a Web page or Web clip 701A on which the focus is finally placed in the Web information integration screen 701 shown in FIG. 9A is used as key information. Further, since the Web information integration screen 702 shown in FIG. 9B is configured by one Web page, a corporation associated with “hatsushiba.co.jp” that is the site name of the Web information integration screen 702 is used as key information. Additionally, news associated with weathercast that is the site name of a Web page or Web clip 703A on which the focus is finally placed in the Web information integration screen 703 shown in FIG. 9C is used as key information.

(3) The television receiver accesses a site that distributes Web pages or Web clips in the Web information integration screen based on Web information integration screen data when the Web information integration screen is not displayed. Then, if information included in the Web page or Web clip is updated, it stores the updated date and time in the storage module 16. A keyword (the highest-frequency word or site name) acquired from the Web page or Web clip that is lately updated based on the updated date and time stored in the storage module 16 is used as key information.

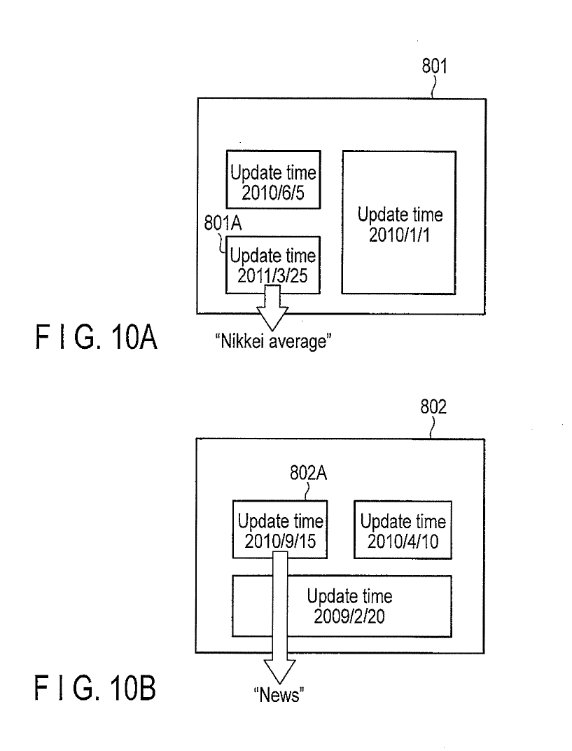

For example, a case where Web information integration screens 801 and 802 shown in FIG. 10(A) and FIG. 10(B) are taken as an example is explained. The Nikkei stock average that is a highest-frequency word of a Web page or Web clip 801A lately updated in the Web information integration screen 801 shown in FIG. 10(A) is used as key information. Further, news that is a highest-frequency word of a Web page or Web clip 802A lately updated in the Web information integration screen 802 shown in FIG. 10(B) is used as key information.

(4) The television receiver calculates the frequency at which the focus is placed on each Web page or Web clip each time the focus is placed on the Web page or Web clip in the Web information integration screen and stores the frequency for each Web page or Web clip in the storage module 16. A keyword (the highest-frequency word or site name) acquired from the Web page of Web clip having the highest frequency is used as key information.

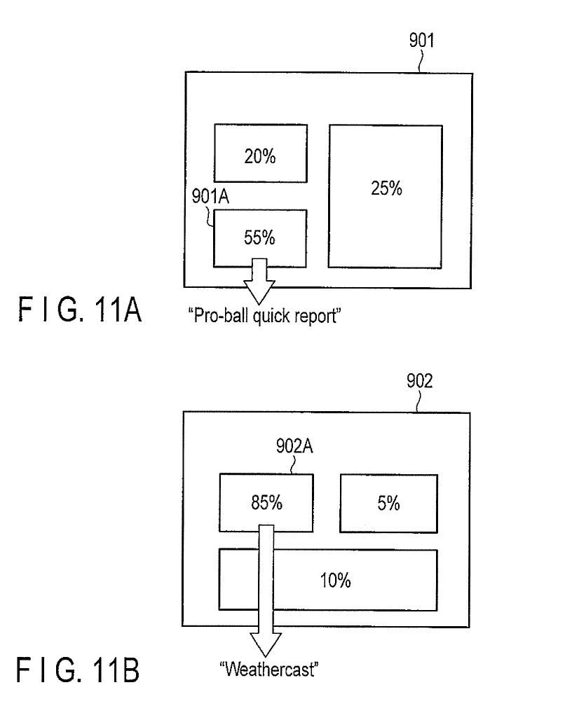

For example, a case where Web information integration screens 901 and 902 shown in FIG. 11A and FIG. 11B are taken as an example is explained. A pro-ball quick report that is the site name of a Web page or Web clip 901A having high frequency in the Web information integration screen 901 shown in FIG. 11A is used as key information. Further, weathercast that is the site name of a Web page or Web clip 902A having high frequency in the Web information integration screen 902 shown in FIG. 11B is used as key information.

(5) The television receiver calculates the frequency at which the focus is placed on each Web page or Web clip in a time zone including the time at which the focus is placed each time the focus is placed on the Web page or Web clip in the Web information integration screen and stores the frequency of each Web page or Web clip in the storage module 16. A keyword (the highest-frequency word or site name) acquired from the Web page of Web clip having the highest frequency in the time zone including time at which a command of display of the Web information integration screen is issued is used as key information.

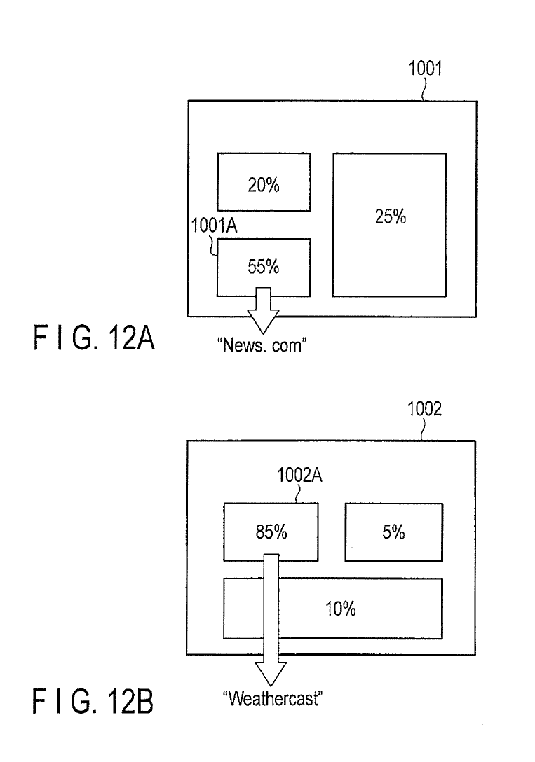

For example, a case where Web information integration screens 1001 and 1002 shown in FIG. 12A and FIG. 12B are taken as an example is explained. “News.com” that is the site name of a Web page or Web clip 1001A having high frequency in the Web information integration screen 1001 shown in FIG. 12A is used as key information. Further, “weathercast” that is the site name of a Web page or Web clip 1002A having high frequency in the Web information integration screen 1002 shown in FIG. 12B is used as key information.

(6) The television receiver sets the date and time at which Web information integration screen data is generated as key information. When the date and time is set as key information, Web information integration screen data whose generation time is closest to the time at which a command of display of the Web information integration screen is issued is selected.

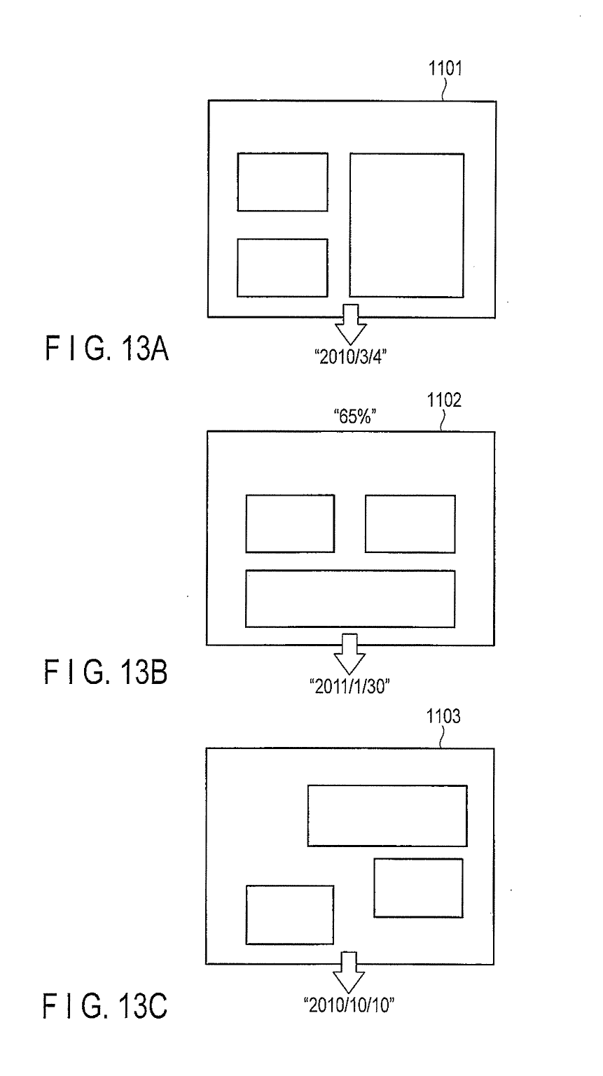

For example, a case where Web information integration screens 1101, 1102 and 1103 shown in FIG. 13A, FIG. 13B and FIG. 13C are taken as an example is explained. “2010/3/4” that is the generation time of Web information integration screen data corresponding to the Web information integration screen 1101 shown in FIG. 13A is used as key information. Further, “2011/1/30” that is the generation time of Web information integration screen data corresponding to the Web information integration screen 1102 shown in FIG. 13B is used as key information. Additionally, “2010/10/10” that is the generation time of Web information integration screen data corresponding to the Web information integration screen 1103 shown in FIG. 13C is used as key information.

Appearance time information of a performer of a program broadcasted may be set as in-device information and the final access time of Web information integration screen data may be set as key information of Web information integration screen data. In this case, Web information integration screen data is selected by the following procedure.

1. Retrieve appearance program of performer

2. Retrieve broadcasting time of appearance program (one time zone is acquired by adequate method in the case of plural broadcasting times)

3. Select Web information integration screen data whose broadcasting time zone is close to time zone of final access time of Web information integration screen data

(Example of In-Device Information)

An example of in-device information is shown below.

1. EPG data of program viewed until latest time

2. Time at which display command of Web information integration screen is received

3. Name or genre of program recorded in storage device when program data can be recorded in storage device such as hard disk drive

4. Genre or program that is frequently viewed

5. Keyword or genre used at retrieval time using EPG data

6. Information (program name, genre, performer or the like) of program retrieved by using EPG data

7. Information (program name or genre) of program retrieved by using retrieval site

8. Information of site retrieved by using retrieval site

9. Object displayed when display command of Web information integration screen is received

10. Character data extracted by speech recognition based on audio data included in program data viewed when display command of Web information integration screen is received

The television receiver 10 includes a processor that executes a program and is one type of a computer.

The whole procedure of the process of displaying the information integration screen of the present embodiment can be performed by software. Therefore, the same effect as that of the present embodiment can be realized simply by installing a program used for performing the procedure of the process of displaying the information integration screen in a normal computer, using a computer-readable storage medium having the program stored therein and executing the program.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from spirit of the inventions. The accompanying claims and their equivalents are intended to cover such forms or modifications as would fall within the scope and spirit of the inventions.

What is claimed is:

1. An electronic device comprising:
a storage module configured to store information integration screen information items, each integration screen information item comprising information of one or more Web page and/or specified area of Web page;
a reception module configured to receive broadcasting program data comprising electronic program table data;
a transmission module configured to transmit a display command to display an information integration screen when a signal for displaying the information integration screen is received from an exterior;
a generator configured to generate key information items associated with the information integration screen information items;
a selection module configured to select one information integration screen information item from the information integration screen information items based on in-device information and key information items when the transmission module transmits the display command, the in-device information comprising the electronic program table data acquired from the electronic device, and the key information items associated with the respective information integration screen information items; and
a display data generator configured to generate display data to display, on a display screen, an information integration screen comprising one or more Web page and/or the specified area of Web page, the information integration screen corresponding to the one information integration screen information selected by the selection module.

2. The device of claim 1, wherein the selection module is configured to calculate degrees of association with respective information integration screen information items based on the in-device information and the key information, and to select the one information integration screen information item comprising the highest degree of association.

3. The device of claim 2, further comprising an operation module configured to calculate a reference rate of each of information integration screen information items in time zones according to a display time of an information integration screen which is displayed based on the information integration screen information items,
wherein the selection module is configured to select the one information integration screen information item comprising the highest reference rate in a time zone corresponding to a time at which the display command is transmitted when the highest degree of association is less than a threshold value.

4. The device of claim 1, wherein the in-device information comprises at least one of
electronic program table data of a program corresponding to broadcasting program data received by the reception module when the display command is transmitted,
time at which the display command is transmitted,
a genre of a program corresponding to broadcasting program data which is received with high frequency by the reception module,
a word acquired from the broadcasting program data,
a keyword used at a retrieval time using electronic program table data,
a genre used at the retrieval time,
information of a program retrieved by using the electronic program table data,
a keyword used at the retrieval time using a retrieval site,
information of a program retrieved by using a retrieval site,
an object displayed on a display screen based on the broadcasting program data when the display command is transmitted,
character data extracted by speech recognition from audio data included in the broadcasting program data, and
electronic program table data attached to contents recorded by a recording function of the device.

5. The device of claim 1, further comprising a generation module for generating key information associated with each information integration screen information item,
wherein the generation module performing at least one of
a process of generating, as the key information, a site name of a first web page or a first specified area of Web page which has the largest area in one or more a Web page or a specified area of Web page displayed on a display screen based on an information integration screen information item in the information integration screen information items,
a process of generating, as the key information, a highest-frequency word included in a first web page or a first specified area,
a process of generating, as the key information, genre information included in a second web page or a second specified area of Web page on which focus is lastly placed, when one or more a Web page or a specified area of Web page are displayed on a display screen based on an information integration screen information item in the information integration screen information items,
a process of generating, as the key information, a word included in a third Web page or a third specified area of Web page on which the focus is frequently placed when one or more a Web page or a specified area of Web page are displayed on a display screen based on an information integration screen information item in the information integration screen information items,
a process of generating, as the key information, a word included in a fourth Web page or a fourth specified area of Web page on which the focus is frequently placed at the acquisition time of time information when one or more a Web page or a specified area of Web page are displayed on a display screen based on an information integration screen information item in the information integration screen information items,
a process of generating, as the key information, a rate at which the information integration screen information is displayed at the acquisition time of time information, and
a process of generating, as the key information, date and time at which the information integration screen information is generated.

6. A display method of an electronic device, comprising:
receiving broadcasting program data comprising electronic program table data;
transmitting a display command to display an information integration screen;
generating key information items associated with the information integration screen information items stored in a storage module;
selecting one information integration screen information item from the information integration screen information items based on in-device information and key information items in response to transmission of the display command, the in-device information comprising the electronic program table data acquired from the electronic device, and the key information items associated with the respective information integration screen information items; and
displaying, on a display screen, an information integration screen comprising one or more Web page and/or specified area of Web page that corresponds to the one information integration screen information item.

7. The method of claim 6, further comprising:
calculating degrees of association with respective information integration screen information items based on the in-device information and the key information; and
to selecting the one information integration screen information item comprising the highest degree of association.

8. The method of claim 7, further comprising:
calculating a reference rate of each of information integration screen information items in time zones according to a display time of an information integration screen which is displayed based on information integration screen information items; and
selecting the one information integration screen information item comprising the highest reference rate in a time zone corresponding to a time at which the display command is transmitted when the highest degree of association is less than a threshold value.

9. The method of claim 6, wherein the in-device information includes at least one of
electronic program table data of a program corresponding to broadcasting program data received by the reception module when the display command is transmitted,
time at which the display command is transmitted,
a genre of a program corresponding to broadcasting program data which is received with high frequency by the reception module,
a word acquired from the broadcasting program data,
a keyword used at the retrieval time using electronic program table data,
a genre used at the retrieval time,
information of a program retrieved by using electronic program table data,
a keyword used at the retrieval time using a retrieval site,
information of a program retrieved by using a retrieval site,
an object displayed on a display screen based on the broadcasting program data when the display command is transmitted,
character data extracted by speech recognition from audio data included in the broadcasting program data, and
electronic program table data attached to contents recorded by a recording function of the device.

10. The method of claim 6, wherein generating the key information comprises at least one of
generating, as the key information, a site name of a first web page or a first specified area of Web page which has the largest area in one or more a Web page or a specified area of Web page displayed on a display screen based on an information integration screen information item in the information integration screen information items,
generating, as the key information, a highest-frequency word included in a first web page or a first specified area,
generating, as the key information, genre information included in a second web page or a second specified area of Web page on which focus is lastly placed, when one or more a Web page or a specified area of Web page are displayed on a display screen based on an information integration screen information item in the information integration screen information items,
generating, as the key information, a word included in a third Web page or a third specified area of Web page on which the focus is frequently placed when one or more a Web page or a specified area of Web page are displayed on a display screen based on an information integration screen information item in the information integration screen information items,
generating, as the key information, a word included in a fourth Web page or a fourth specified area of Web page on which the focus is frequently placed at the acquisition time of time information when one or more a Web page or a specified area of Web page are displayed on a display screen based on an information integration screen information item in the information integration screen information items,
generating, as the key information, a rate at which the information integration screen information is displayed at the acquisition time of time information, and
generating, as the key information, date and time at which the information integration screen information is generated.

11. A non-transitory computer-readable storage medium storing computer-executable instructions that, when executed, cause a computer to:
receiving broadcasting program data comprising electronic program table data;
transmitting a display command to display an information integration screen;
generating key information items associated with the information integration screen information items stored in a storage module;
selecting one information integration screen information item from the information integration screen information items based on in-device information and the key information items in response to transmission of the display command, the in-device information comprising the electronic program table data acquired from the electronic device, and the key information items associated with the respective information integration screen information items; and
displaying, on a display screen, an information integration screen comprising one or more Web page and/or specified area of Web page that corresponds to the one information integration screen information item.

12. The storage medium of claim 11 storing computer-executable instructions that, when executed, cause a computer to:
calculate degrees of association with respective information integration screen information items based on the in-device information and the key information; and
to select the one information integration screen information item comprising the highest degree of association.

13. A storage medium of claim 12 storing computer-executable instructions that, when executed, cause the computer to:
calculate a reference rate of each of information integration screen information items in time zones according to a display time of an information integration screen which is displayed based on information integration screen information items; and
select the one information integration screen information item comprising the highest reference rate in a time zone corresponding to a time at which the display command is transmitted when the highest degree of association is less than a threshold value.

14. The storage medium of claim 11, wherein the in-device information includes at least one of
electronic program table data of a program corresponding to broadcasting program data received by the reception module when the display command is transmitted,
time at which the display command is transmitted,
a genre of a program corresponding to broadcasting program data which is received with high frequency by the reception module,
a word acquired from the broadcasting program data,
a keyword used at the retrieval time using electronic program table data,
a genre used at the retrieval time,
information of a program retrieved by using electronic program table data,
a keyword used at the retrieval time using a retrieval site,
information of a program retrieved by using a retrieval site,
an object displayed on a display screen based on the broadcasting program data when the display command is transmitted,
character data extracted by speech recognition from audio data included in the broadcasting program data, and
electronic program table data attached to contents recorded by a recording function of the device.

15. The storage medium of claim 11, wherein generating of the key information comprises at least one of
generating, as the key information, a site name of a first web page or a first specified area of Web page which has the largest area in one or more a Web page or a specified area of Web page displayed on a display screen based on an information integration screen information item in the information integration screen information items,
generating, as the key information, a highest-frequency word included in a first web page or a first specified area,
generating, as the key information, genre information included in a second web page or a second specified area of Web page on which focus is lastly placed, when one or more a Web page or a specified area of Web page are displayed on a display screen based on an information integration screen information item in the information integration screen information items,
generating, as the key information, a word included in a third Web page or a third specified area of Web page on which the focus is frequently placed when one or more a Web page or a specified area of Web page are displayed on a display screen based on an information integration screen information item in the information integration screen information items,
generating, as the key information, a word included in a fourth Web page or a fourth specified area of Web page on which the focus is frequently placed at the acquisition time of time information when one or more a Web page or a specified area of Web page are displayed on a display screen based on an information integration screen information item in the information integration screen information items,
generating, as the key information, a rate at which the information integration screen information is displayed at the acquisition time of time information, and
generating, as the key information, date and time at which the information integration screen information is generated.
